(19) United States
(12) Patent Application Publication
(10) Pub. No.: US 2025/0006421 A1
(43) Pub. Date: Jan. 2, 2025

(54) COIL COMPONENT

(71) Applicant: Taiyo Yuden Co., Ltd., Tokyo (JP)

(72) Inventors: Takayuki Arai, TOKYO (JP); Nami Hamada, Tokyo (JP); Tomoo Kashiwa, TOKYO (JP)

(21) Appl. No.: 18/756,394

(22) Filed: Jun. 27, 2024

(30) Foreign Application Priority Data
Jun. 30, 2023 (JP) 2023-108288
Feb. 15, 2024 (JP) 2024-020807

(51) Int. Cl. H01F 27/29; H01F 27/32

(52) U.S. Cl. CPC H01F 27/292; H01F 27/32

(57) ABSTRACT

A coil component includes a magnetic base body containing a magnetic metal material and having a first surface; a conductor disposed inside the magnetic base body; external electrodes electrically connected to the conductor and extending along the first surface of the magnetic base body, each of the external electrodes having a first electrode portion embedded in the magnetic base body and a second electrode portion exposed from the magnetic base body; and an insulation layer covering an area of the first surface that excludes areas on which the external electrodes are disposed.

### TECHNICAL FIELD

The present invention relates to coil components.

### BACKGROUND ART

As electronic devices become smaller and more sophisticated, there is a demand for higher-density mounting of electronic components on circuit boards. However, in high-density mounting, there is a limit to the number of electronic components that can be mounted on the surface of a circuit board. Accordingly, smaller electronic components with high performance are demanded for increasing the number of electronic components that can be mounted on a circuit board, and for more miniaturization and higher performance of electronic devices.

For miniaturizing electronic components, magnetic elements in coil components have been made of magnetic metal materials instead of ferrite magnetic materials. Use of magnetic metal materials with high magnetic saturation characteristics reduces the volume of magnetic material needed for magnetic saturation.

Since such magnetic metal materials have low electrical resistance, coil components in which such magnetic metal materials are used need to have electrical insulation on the surface on which external electrodes are disposed. Accordingly, a structure in which the outside of the component body is covered with an insulation layer is sometimes adopted.

For example, Patent Document 1 discloses an electronic component including an insulator containing a magnetic metal powder and a resin coating film on the insulator.

### BACKGROUND DOCUMENT(S)

### Patent Document(s)

Patent Document 1: JP 2016-178282 A

### SUMMARY OF THE INVENTION

However, external electrodes should have a sufficient thickness whether the coil component is mounted on the surface of a circuit board or embedded inside the circuit board. Therefore, in a case in which an insulation layer is provided on the component body, the insulation layer also has some thickness, causing the external dimensions of the coil component to increase.

Conversely, if the external dimensions are fixed, the component body including the magnetic metal materials should have reduced dimensions in view of the thickness of the insulation layer, which will lower the performance of the coil component. Accordingly, there is a limit to miniaturization of the coil component.

Accordingly, the present invention provides a smaller coil component having an insulation layer.

According to one aspect of the present invention, there is provided a coil component including a magnetic base body containing a magnetic metal material and having a first surface; a conductor disposed inside the magnetic base body; external electrodes electrically connected to the conductor and extending along the first surface of the magnetic base body, each of the external electrodes having a first electrode portion embedded in the magnetic base body and a second electrode portion exposed from the magnetic base body; and an insulation layer covering an area of the first surface that excludes areas on which the external electrodes are disposed.

The second electrode portion may be located within a contour of the corresponding first electrode portion when viewed in a direction perpendicular to the first surface.

Peripheries of the first electrode portion may be covered with the insulation layer.

The first electrode portions may have a thickness that is greater than a thickness of the second electrode portions.

In the direction perpendicular to the first surface, the external electrodes may protrude beyond the insulation layer.

At least a part of a surface of the insulation layer may have a sloping surface that is inclined to be closer to the first surface as a distance from the external electrodes increases.

On the first surface, the insulation layer may be wider than the second electrode portions.

The magnetic base body may have multiple surfaces including the first surface, and the external electrodes may be disposed only on the first surface among the multiple surfaces.

The insulation layer may have a surface roughness that is less than that of the magnetic base body.

The insulation layer may be made of at least one insulating material among resins, glass materials, and metal oxides.

In the direction perpendicular to the first surface, the insulation layer may protrude beyond the external electrodes.

The first electrode portions may be mainly composed of a metallic element that is the same as that for the conductor.

The second electrode portions may contain Cu at least on surfaces thereof.

The coil component may include three or more external electrodes.

The coil component may include multiple conductors, each of which may be an inductor element.

According to the present invention, it is possible to reduce the size of the coil component having an insulation layer.

### BRIEF DESCRIPTION OF THE DRAWINGS

With reference to the accompanying drawings, various embodiments of the present invention will be described hereinafter. In the drawings:

FIG. 1 is perspective view showing a coil component according to a first embodiment of the present invention;

FIG. 2 is a cross-sectional view of the coil component taken along line I-I in FIG. 1;

FIG. 3 shows a first step in a manufacturing method of a coil component according to a comparative example;

FIG. 4 shows a second step in the manufacturing method of the coil component according to the comparative example;

FIG. 5 shows a third step in the manufacturing method of the coil component according to the comparative example;

FIG. 6 shows a fourth step in the manufacturing method of the coil component according to the comparative example;

FIG. 7 shows a first step in a manufacturing method of the coil component according to the first embodiment;

FIG. 8 shows a second step in the manufacturing method of the coil component according to the first embodiment;

FIG. 9 shows a third step in the manufacturing method of the coil component according to the first embodiment;

FIG. 10 shows a fourth step in the manufacturing method of the coil component according to the first embodiment;

FIG. 11 is a cross-sectional view showing a coil component of a first modification according to the first embodiment;

FIG. 12 is a cross-sectional view showing a coil component of a second modification according to the first embodiment;

FIG. 13 is a cross-sectional view showing a coil component of a third modification according to the first embodiment;

FIG. 14 is a cross-sectional view showing a coil component of a fourth modification according to the first embodiment;

FIG. 15 is perspective view showing a coil component according to a second embodiment of the present invention;

FIG. 16 is a cross-sectional view taken along line II-II in FIG. 15;

FIG. 17 is a cross-sectional view taken along line III-III in FIG. 15; and

FIG. 18 is a cross-sectional view showing a circuit board arrangement according to a third embodiment of the present invention.

### DESCRIPTION OF EMBODIMENTS

The following embodiments are not intended to limit the present invention, and not all of the features in the embodiments are essential for the present invention. The embodiments may be modified or changed as appropriate depending on specifications of the devices to which the present invention is applied and conditions (conditions of use, environment of use, etc.).

The technical scope of the present invention is defined by the accompanying claims and is not limited by the following individual embodiments. The accompanying drawings used for the following description may differ in scale and shape from the actual structure for easy understanding of the embodiments. In the drawings, the same reference symbols will be used for identifying the same or similar components.

### First Embodiment

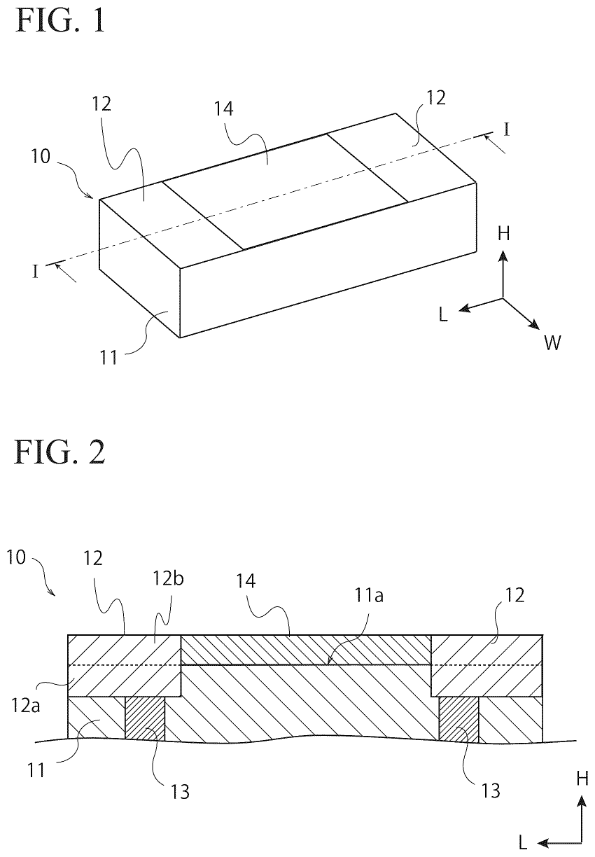

FIGS. 1 and 2 show a coil component according to a first embodiment of the present invention. FIG. 2 shows a cross-section taken along line I-I in FIG. 1.

The coil component 10 according to the first embodiment has a magnetic base body 11 made of a magnetic metal material, two external electrodes 12 disposed on a first surface 11a of the magnetic base body 11, a conductor disposed in a part of the magnetic base body 11, and an insulation layer 14 disposed between the two external electrodes 12. An example of the conductor is an internal conductor 13 disposed inside the magnetic base body 11. The term “disposed on a/the surface” means that the external electrodes 12 are located at positions that are visible when looking at the surface, and the external electrodes 12 may protrude beyond the plane of the surface or may be located at positions recessed behind the plane of the surface. As described later, the external electrodes 12 protrude partly beyond the plane of the first surface 11a and are partly embedded in the first surface 11a. The extent of the first surface 11a of the magnetic base body 11 is the entire area limited by the contour thereof, so that the first surface 11a includes the sections in which the external electrodes 12 are located. In other words, the first surface 11a may be an uneven surface having depressions on which external electrodes 12 are provided.

The coil component 10 may be mounted on the surface of a circuit board or embedded in a circuit board together with resin. Alternatively, the coil component 10 may be packaged together with resin as a packaged component. In a case in which the coil component 10 is embedded in a circuit board or packaged, the coil component 10 may be encapsulated by resin.

For example, soft magnetic metal particles are used for the magnetic material of the magnetic base body 11. The magnetic base body 11 may be formed by any known technology.

In this specification, unless otherwise understood from context, directions are based on the L-axis, W-axis″ and H-axis″ in FIG. 1, and are referred to as the length direction, width direction, and height direction.

The coil component 10 has a rectangular parallelepiped contour. That is, the coil component 10 has end surfaces at both ends in the length direction L, top and bottom surfaces at both ends in the height direction H, and a front surface and a rear surface at both ends in the width direction W. All or some of the surfaces of the coil component 10 may be flat or curved. In addition, some of the eight vertices and twelve edges of the coil component 10 may be rounded or chamfered.

In this specification, even if some of the surfaces of the coil component 10 are curved or uneven and/or even if some of vertices and edges are rounded or chamfered, the contour of the coil component 10 is referred to as a “rectangular parallelepiped.” In other words, the term “rectangular parallelepiped” used herein does not necessarily mean a rectangular parallelepiped in the strict mathematical sense.

In the first embodiment, the first surface 11a of the magnetic base body 11 is a principal surface of the coil component 10. The principal surface of the coil component 10 is a mounting surface that faces a surface of a circuit board if the coil component 10 is mounted on the surface of the circuit board. In the first embodiment, since the external electrodes 12 are disposed only on the first surface 11a among the surfaces of the magnetic base body 11, the effect of the thickness of the external electrodes 12 on the dimensions of the coil component 10 is limited only to the height direction H that is substantially perpendicular to the first surface 11a, which will contribute to miniaturizing the coil component 10.

The coil component 10 according to the first embodiment has two external electrodes 12 separated from each other, for example, in the length direction L, on the first surface 11a of the magnetic base body 11. A plating layer is provided on the surface of each of the external electrodes 12 for the purpose of electrical connection with elements on a circuit board. Preferably, the plating layer contains Cu for better connectivity with the elements on the circuit board.

Each external electrode 12 extends on the first surface 11a along the length direction L and the width direction W. In the height direction H, each external electrode 12 has a first electrode portion 12a embedded in the magnetic base body 11 and a second electrode portion 12b exposed from the magnetic base body 11. The first and second electrode portions 12a and 12b are made of, for example, Ag or Cu. The first and second electrode portions 12a and 12b may be made of the same material or different materials.

Each external electrode 12 is electrically connected to one of ends of the internal conductor 13 via the first electrode portion 12a. The internal conductor 13 may be any conductor that has an inductance. For example, the conductor may be a coil wound a predetermined number of times around the coil axis although the illustration thereof is omitted.

The coil component 10 is a small electronic component, and the area and volume thereof are small. For example, in the first embodiment, an internal conductor 13 and two external electrodes 12 constitute an electrically connected element, and the area of the first surface 11a is not less than 0.5 mm [symbol] 2 and not more than 1.5 mm [symbol] 2.

For example, in a case in which a coil component 10 has two electrically connected elements, the area of the first surface 11a is not less than 2.0 mm [symbol] 2 and not more than 3.5 mm [symbol] 2 since the distance between the external electrodes 12 is a constraint. The external electrodes 12 are disposed with a spacing of, for example, 0.5 mm or less.

The insulation layer 14 is formed of an electrical insulating material with excellent insulation properties and covers the area between the external electrodes 12. The insulation layer 14 has a higher electrical resistivity than that of the magnetic base body 11. The material of the insulation layer 14 is, for example, a resin material such as a silicon resin, an epoxy resin, or a phenol resin; a glass material such as a borosilicate glass; or a metal oxide such as an oxide containing P (phosphorus). Thermosetting materials are preferred as the material of the insulation layer 14.

In the coil component 10 of the first embodiment, all of the area between the external electrodes 12 on the first surface 11a of the magnetic base body 11 is covered with the insulation layer 14. On the first surface 11a, the insulation layer 14 is wider than the second electrode portions 12b. In other words, the total area of the insulation layer 14 is greater than the total area of the second electrode portions 12b.

Part of the magnetic base body 11 in which magnetic metal material is used may have a lower surface resistance than a magnetic base body in which ferrite is used. Accordingly, the insulation layer 14 is disposed on the magnetic base body 11. The insulation layer 14 prevents the occurrence of short circuits caused by a decrease in insulation resistance between the external electrodes 12 even if the coil component is provided with a plating layer on each of the external electrodes 12. On the other hand, since the first electrode portions 12a of the external electrodes 12 are embedded in the magnetic base body 11, the thickness of the insulation layer 14 may be reduced to correspond to the thickness of the second electrode portions 12b of the external electrodes 12. Therefore, the coil component 10 including the insulation layer 14 can be made smaller.

A formation process of the insulation layer 14 includes applying an insulating material, which becomes the insulation layer 14, to the surface of the magnetic base body 11, thermal curing of the insulating material, and surface processing of the insulation layer 14, and as a result of the formation process, an insulation layer 14 with a necessary thickness is obtained. As for the surface processing, processing means for, for example, sandblasting, grinding, barrel polishing, laser light irradiation, and/or solvent etching may be used.

The surface roughness of the insulation layer 14 is less than the surface roughness of the first surface 11a of the magnetic base body 11. In other words, the surface of the insulation layer 14 is smoother than that of the first surface 11a of the magnetic base body 11. The smoother surface of the insulation layer 14 facilitates flow of a sealing resin during the resin encapsulation process, thereby minimizing void formation.

The surface roughness of the insulation layer 14 and the surface roughness of the first surface 11a of the magnetic base body 11 can be expressed in terms of arithmetic average height Sa, which is calculated using, for example, a measuring instrument in accordance with ISO 25178. The arithmetic average height Sa is measured by a commercially available instrument capable of measuring the arithmetic average height Sa, for example, a shape analysis laser microscope (“VK-X250”) manufactured by Keyence Corporation (Osaka, Japan).

### Method of Manufacturing Coil Component

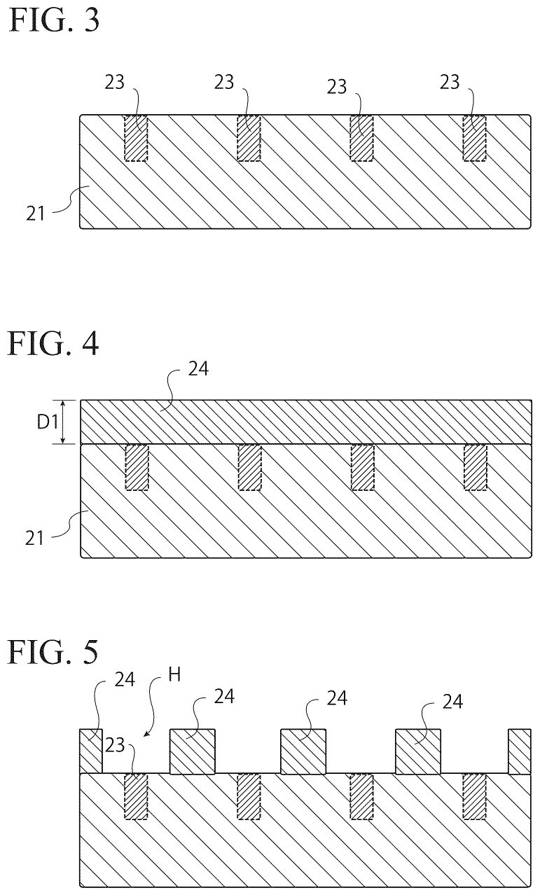

FIGS. 3 to 6 show a manufacturing method of the coil component according to a comparative example, and FIGS. 7 to 10 show a manufacturing method of the coil component 10 according to the embodiment.

For the comparative example, in a first step shown in FIG. 3, a magnetic base body part 21 made of a magnetic metal material and internal conductor parts 23 made of a conductor are formed. The magnetic base body part 21 corresponds to the magnetic base body 11, and the internal conductor parts 23 correspond to the internal conductors 13. In FIGS. 3 to 10, only ends of the internal conductor parts are shown schematically.

A formation process of the magnetic base body part 21 and the internal conductor parts 23 is executed by a combination of printing or plating of a conductor pattern on a sheet of a magnetic metal material and lamination of multiple sheets. The internal conductor parts 23 are formed such that ends thereof are exposed on a surface of the magnetic base body part 21.

In a second step shown in FIG. 4, an insulation layer 24 is formed on the surface of the magnetic base body part 21 (the surface on which ends of the internal conductor parts 23 are exposed). The insulation layer 24 is formed to have a sufficient thickness D1 since the thickness D1 should be equivalent to the thickness of the external electrodes 12.

In a third step shown in FIG. 5, holes H are formed in the insulation layer 24. That is, multiple portions of the insulation layer 24 are removed to expose the internal conductor parts 23.

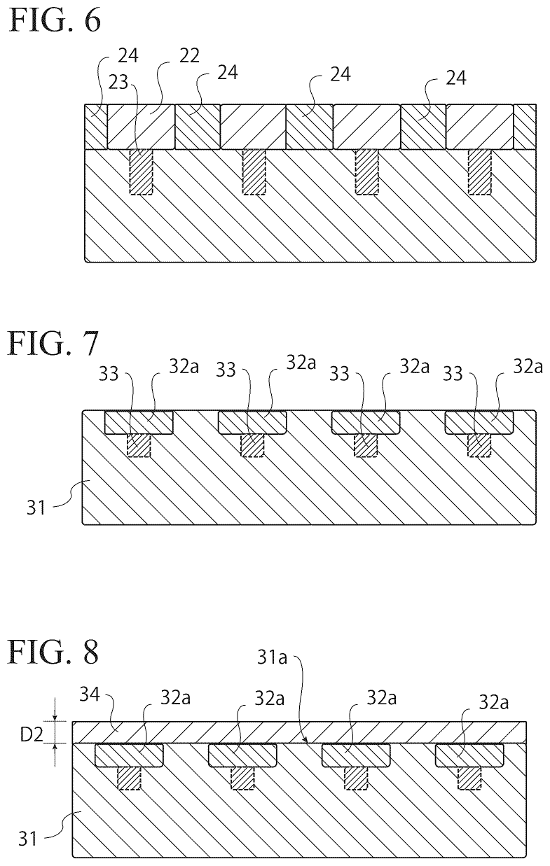

In a fourth step shown in FIG. 6, external electrodes 22 are formed within the holes H in the insulation layer 24, for example, by plating. The insulation layer 24 corresponds to the insulation layer 14, and the external electrodes 22 correspond to the external electrodes 12. Since the external electrodes 22 should have a certain thickness, the aforementioned thickness D1 of the insulation layer 24 is also large, making it difficult to miniaturize the coil component. In addition, the large thickness D1 of the insulation layer 24 is likely to cause formation of voids when the insulation layer 24 is formed in the second step shown in FIG. 4.

In contrast, for the coil component 10 according to the embodiment, in a first step shown in FIG. 7, a magnetic base body part 31 made of a magnetic metal material, internal conductor parts 33 made of a conductor, and first electrode portions 32a are formed. The magnetic base body part 31 corresponds to the magnetic base body 11, and the internal conductor parts 33 correspond to the internal conductors 13. The first electrode portions 32a correspond to the first electrode portions 12a. A formation process of the magnetic base body part 31, the internal conductor parts 33, and the first electrode portions 32a is also executed by a combination of printing or plating of a conductor pattern on a sheet of a magnetic metal material and lamination of multiple sheets. Accordingly, it is easy to form the internal conductor parts 33 and the first electrode portions 32a if they are made of the same type of conductor (i.e., if they are mainly composed of the same metallic element).

The magnetic base body part 31, the internal conductor parts 33, the first electrode portions 32a, etc. may be formed to be a single laminate corresponding to multiple coil components 10. The single laminate may subsequently be cut or separated into multiple coil components 10, so that the efficiency of manufacturing coil components 10 are improved.

In a second step shown in FIG. 8, an insulation layer 34 is formed on the first surface 31a of the magnetic base body part 31. The thickness D2 of the insulation layer 34 is equivalent to the thickness of the second electrode portions 12b of the external electrodes 12 shown in FIG. 2, so that the thickness D2 is less than the thickness D1 of the insulation layer 24 in the comparative example, which contributes to miniaturizing the coil component. The insulation layer 34 may be formed at the time of forming the above-mentioned single laminate or after the separation.

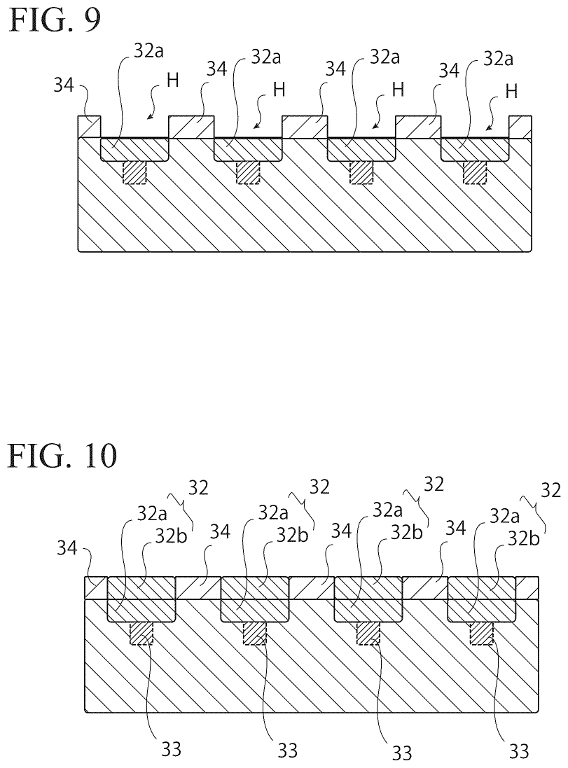

In a third step shown in FIG. 9, multiple portions of the insulation layer 34 are removed to form holes H for exposing the first electrode portions 32a. Since each of the holes H is formed within an extent defined by the contour of the first electrode portion 32a, it is possible to avoid the surface of the magnetic base body portion 31 surrounding the first electrode portions 32a from being damaged. Instead of removing multiple portions of the insulation layer 34, the holes H for exposing the first electrode portions 32a may be formed when the insulation layer 34 is formed.

In a fourth step shown in FIG. 10, second electrode portions 32b are formed on the exposed portions of the first electrode portions 32a, respectively, by, for example, plating. The second electrode portions 32b correspond to the second electrode portions 12b. As a result, external electrodes 32 each having the first electrode portion 32a and the second electrode portion 32b are formed. The external electrodes 32 correspond to the external electrodes 12. Although the external electrodes 32 have a sufficient thickness, since the first electrode portions 32a of the external electrodes 32 are embedded in the magnetic base body part 31, the thickness of the insulation layer 34 can be minimized, thereby contributing to miniaturizing the coil component 10.

### Modifications

Next, modifications of the coil component 10 will be described. In the following, duplicate explanations will be omitted for structural elements that are similar to those in the above-described first embodiment.

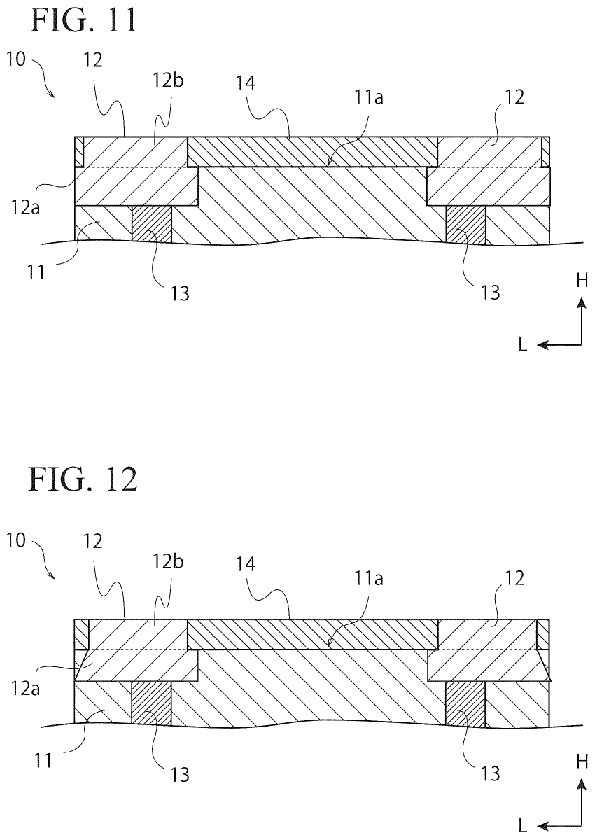

FIGS. 11 to 13 show first to third modifications in which the shape of the external electrodes 12 is different from that in the first embodiment. FIG. 14 shows a fourth modification in which the shape of the insulation layer 14 is different from that in the first embodiment. FIGS. 11 to 14 show the same cross section as that shown in FIG. 2.

In the first modification shown in FIG. 11, the second electrode portions 12b are thinner and smaller in area than the first electrode portions 12a. That is, in the thickness direction perpendicular to the first surface, the thickness of the first electrode portions 12a is greater than the thickness of the second electrode portions 12b. In addition, the second electrode portions 12b are located within the contour of the first electrode portions 12a, respectively when viewed in the direction perpendicular to the first surface 11a. Since the second electrode portions 12b are thinner than the first electrode portions 12a, the thickness of the insulation layer 14 can be made smaller. Since the first electrode portions 12a are wider and thicker than the second electrode portions 12b, the contact areas, and thus the adhesiveness of the first electrode portions 12a to the magnetic base body 11 and the durability of the external electrodes 12 can be improved.

Since the second electrode portions 12b are smaller in area than the first electrode portions 12a, for example, in the third step shown in FIG. 9, the internal surfaces of the holes H can be located within the first electrode portions 12a. Therefore, no damage is applied to the surroundings of the first electrode portions 32a when forming the holes H, and no damage is applied to the first surface 11a of the magnetic base body 11. In addition, since the second electrode portions 12b are smaller in area than the first electrode portions 12a, the peripheries of the first electrode portions 12a are covered with the insulation layer 14.

In the second modification shown in FIG. 12, a portion of each first electrode portion 12a is wedge-shaped. At the wedge-shaped portion, the outer edge of the first electrode portion 12a widens as the distance from the first surface 11a increases, thereby further increasing the contact area, and thus the adhesiveness of the first electrode portion 12a to the magnetic base body 11. Therefore, even if the area of the external electrode 12 is small, the electrode is prevented from being peeled off.

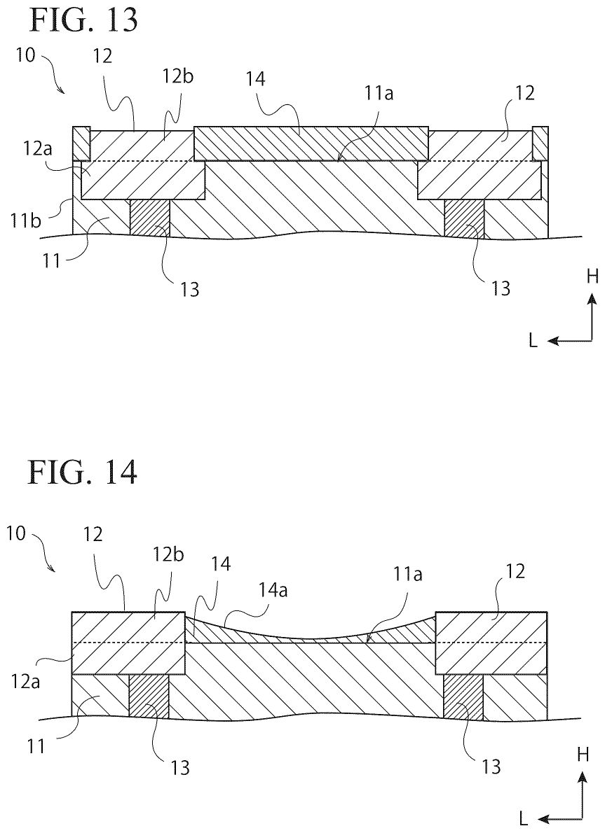

In the third modification shown in FIG. 13, the outer periphery of each first electrode 12a is located inside the corresponding side surface 11b of the magnetic base body 11. This structure also increases the contact area, and thus the adhesiveness between the first electrode portion 12a and the magnetic base body 11, thereby improving the durability of the external electrodes 12.

In the third modification, the insulation layer 14 has a thickness that is greater than that of the second electrode portions 12b and protrudes beyond the external electrode 12 in the thickness direction that is perpendicular to the first surface 11a. Accordingly, the insulation layer 14 having the smoother surface improves handling of the coil component 10 and the resin encapsulation process.

In the fourth modification shown in FIG. 14, the thickness of the insulation layer 14 relative to the first surface 11a is larger in the vicinities of the external electrodes 12 and is smaller in the central portion of the insulation layer 14. For example, the insulation layer 14 has a concave or sloping surface 14a. The greater the distance from the external electrodes 12, the less the distance between the sloping surface 14a and the first surface 11a. The shape of the insulation layer 14 facilitates flow of the sealing resin during the resin encapsulation process, thereby minimizing void formation. Furthermore, in the fourth modification, the external electrodes 12 have a thickness that is greater than that of the insulation layer 14 and protrude beyond the insulation layer 14 in the thickness direction that is perpendicular to the first surface 11a, so that the flow of the sealing resin is further improved during the resin encapsulation process.

The thickness at the center of the insulation layer 14 is preferably 0.2 times or less than the thickness of the second electrode portion 12b (i.e., the distance between the external surface of the second electrode portion 12b and the first surface 11a). If the thickness at the center of the insulation layer 14 is 0.2 times or less than the thickness of the second electrode portion 12b, a large space is secured between the insulation layer 14 and a plane with which the coil component 10 is in contact during the resin encapsulation process, so that the sealing resin can easily flow along the sloping surface 14a of the insulation layer 14. In order to secure a larger space for the resin to flow during the resin encapsulation process, the thickness at the center of the insulation layer 14 is more preferably 0.1 times or less than the thickness of the second electrode portion 12b, and may even be so small that it is difficult to measure.

The insulation layer 14, which has a smaller thickness at the center, is formed, for example, by surface processing. Surface processing of the insulation layer 14 may be performed by means for sandblasting, grinding, barrel polishing, and/or other known surface processing. In barrel polishing, abrasive media with a diameter that is greater than the space between the external electrodes 12 are used, so that the abrasive media are in contact with the center of the insulation layer 14 while they are not in contact with the ends of the insulation layer 14 in the vicinities of the external electrodes 12. Such surface processing forms the top sloping surface 14a of the insulation layer 14 into a curved surface that is concave toward the center.

### Second Embodiment

Next, another coil component according to a second embodiment of the present invention will be described.

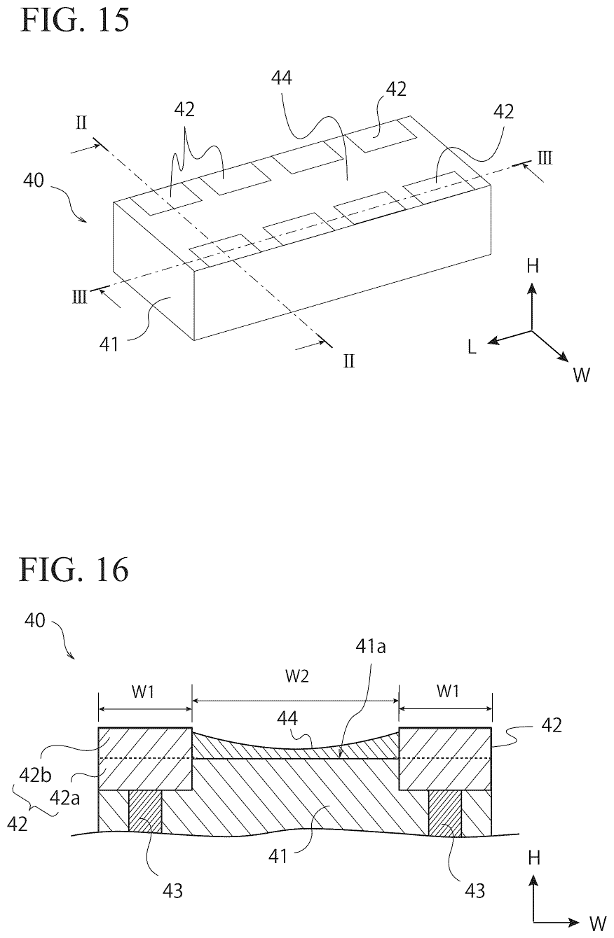

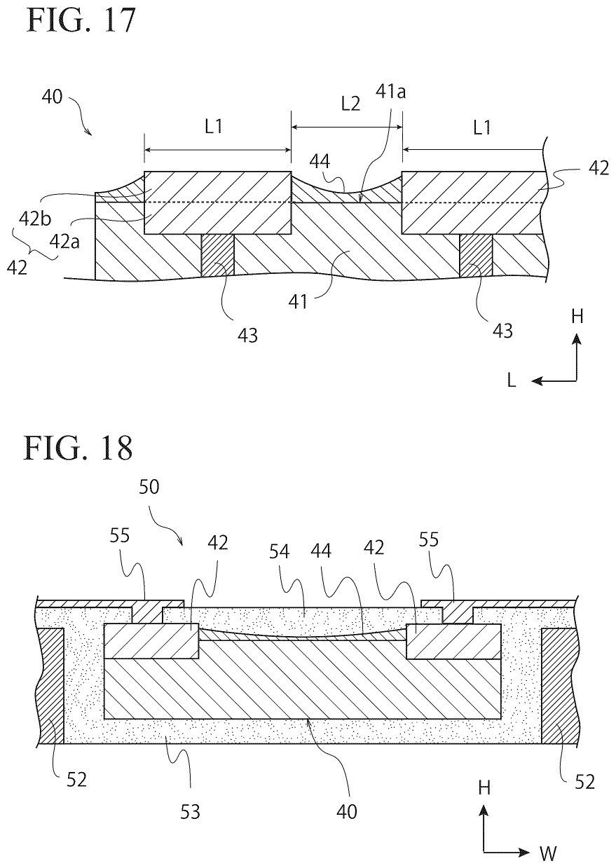

FIGS. 15 to 17 show a coil component according to the second embodiment of the present invention. FIG. 16 shows a cross-section taken along line II-II in FIG. 15, and FIG. 17 shows a cross-section taken along line III-III in FIG. 15.

The coil component 40 according to the second embodiment has a magnetic base body 41 made of a magnetic metal material, multiple external electrodes 42 disposed on a first surface 41a of the magnetic base body 41, internal conductors 43 disposed inside the magnetic base body 41, and an insulation layer 44 disposed between the external electrodes 42. The magnetic base body 41, the external electrodes 42, the internal conductors 43, and the insulation layer 44 in the second embodiment correspond to the magnetic base body 11, the external electrodes 12, the internal conductor 13, and the insulation layer 14 in the first embodiment, respectively.

The coil component 40 according to the second embodiment is an array-type electronic component including multiple elements each having two external electrodes 42 and an internal conductor 43 that is electrically connected with the two external electrodes 42. In such an array type electronic component, multiple elements are packaged as a single component, so as to reduce the mounting space for the multiple elements. The coil component 40 has multiple internal conductors 43, each of which is, for example, an inductor element.

The coil component 40 with multiple elements has three or more external electrodes 42 (eight external electrodes 42 exemplified in FIG. 15). In the coil component 40 of the second embodiment, the eight external electrodes 42 are arranged on the first surface 41a and are, for example, spaced apart from each other in the length direction L and the width direction W, respectively. That is, four external electrodes 42 are aligned in the length direction L and two external electrodes 42 are aligned in the width direction W.

The multiple elements in the coil component 40 may have equivalent characteristics to each other and may be independent of each other in a circuit. The coil component 40 may have multiple elements with different characteristics, or a combination of multiple elements that interact magnetically and/or electrically, and the combination may be, e.g., a transformer, an LC filter, etc.

Also in the coil component 40 of the second embodiment, each external electrode 42 has a first electrode portion 42a embedded in the magnetic base body 41 and a second electrode portion 42b exposed from the magnetic base body 41, so that the thickness of the insulation layer 44 disposed between the external electrodes 42 can be minimized, thereby contributing to miniaturizing the coil component 40.

In a manner similar to the fourth modification of the first embodiment shown in FIG. 14, the insulation layer 44 in the second embodiment has a thickness that is larger in the vicinities of the external electrodes 42 and smaller in the central portion of the insulation layer 44. This applies to both the width direction W (see FIG. 16) and the length direction L (see FIG. 17). The insulation layer 44 in the second embodiment has a curved surface in the width direction W and also in the length direction L.

On the first surface 41a, the total area of the insulation layer 44 is greater than the total area of the eight external electrodes 42. Accordingly, the insulation layer 44 maintains insulation between the external electrodes 42.

In FIG. 17, an example is shown in which the dimension (length) L1 of the external electrodes 42 in the length direction L is greater than the dimension L2 of branches of the insulation layer 44 (i.e., the spacing between the external electrodes 42) in the length direction L. Conversely, the dimension L2 may be greater than the dimension L1.

If the dimension L2 of the branches of the insulation layer 44 in the length direction L is less than the dimension L1 of the external electrodes 42 in the length direction L, the dimension (width) W2 of the wide portion of the insulation layer 44 in the width direction W is preferably greater than the dimension (width) W1 of the external electrodes 42 in the width direction W as shown in FIG. 16. As a result, on the first surface 41a, the total area of the insulation layer 44 is greater than the total area of the external electrodes 42 as described above. In particular, as shown in FIG. 16, in a case in which two external electrodes 42 are arranged in the width direction W, the dimension W2 of the wide portion of the insulation layer 44 in the width direction W is preferably greater than the sum of the dimensions W1 of the two external electrodes 42 in the width direction W (that is, twice the dimension W1), so that the total area of the insulation layer 44 is sufficiently greater than the total area of the external electrodes 42.

Conversely, if the dimension W2 of the wide portion of the insulation layer 44 in the width direction W is less than the dimension W1 of the external electrodes 42 in the width direction W, the dimension L2 of the branches of the insulation layer 44 in the length direction L is preferably greater than the dimension L1 of the external electrode 42 in the length direction L in order that the total area of the insulation layer 44 is greater than the total area of the external electrodes 42. In other words, the spacing between the external electrodes 42 along the width direction W and the spacing between the external electrodes 42 along the length direction L are negatively correlated.

In a case in which the dimension of the coil component 40 is greater in the length direction L than in the width direction W, it is preferable in design that the external electrodes 42 be arranged more in the length direction L than in the width direction W. Therefore, the spacing between the external electrodes 42 in the shorter direction of the coil component 40 is preferably greater than the spacing of the external electrodes 42 in the longitudinal direction of the coil component 40. In this case, the spacing between the external electrodes 42 in the shorter direction of the coil component 40 should be greater than the dimension of the external electrodes 42 in the shorter direction to provide sufficient insulation.

### Third Embodiment

Next, a third embodiment according to the present invention will be described.

FIG. 18 is a cross-sectional view of a circuit board arrangement according to the third embodiment of the present invention.

In the third embodiment, the coil component 40 according to the second embodiment described above is built into a circuit board arrangement 50.

The circuit board arrangement 50 has the coil component 40, an insulation layer 52, a first resin layer 53, a second resin layer 54, and a wiring pattern 55.

The insulation layer 52 is part of a multilayer printed circuit board or a substrate of a circuit board. The insulation layer 52 is formed of an electrical insulating material such as a glass-epoxy composite. The coil component 40 is placed in a hole formed in the insulation layer 52 or disposed between two adjacent insulation layers 52.

The first resin layer 53 is formed around the coil component 40 that is placed in the hole of the single insulation layer 52 or disposed between the two adjacent insulation layers 52. The first resin layer 53 is formed, for example, of a thermosetting resin.

The second resin layer 54 is formed to cover the insulation layer 44 of the coil component 40. The second resin layer 54 may be formed of the same thermosetting resin as that used for the first resin layer 53. The second resin layer 54 encapsulates or seals the coil component 40 in the circuit board arrangement 50. The curved surface of the insulation layer 44 facilitates the flow of the resin when the second resin layer 54 is formed (when the resin encapsulation process is conducted). Accordingly, formation of voids in the second resin layer 54 that encapsulates the coil component 40 can be minimized.

The wiring pattern 55 is formed through a formation process of via holes in the second resin layer 54, a plating process, and an etching process, and is electrically connected to the external electrodes 42.

The coil component 40 is thus built into the circuit board arrangement 50, so that the component mounting density in the circuit board arrangement 50 can be improved and contribute to miniaturization of electronic devices.

What is claimed is:

1. A coil component comprising:
a magnetic base body containing a magnetic metal material and having a first surface;
a conductor disposed inside the magnetic base body;
external electrodes electrically connected to the conductor and extending along the first surface of the magnetic base body, each of the external electrodes having a first electrode portion embedded in the magnetic base body and a second electrode portion exposed from the magnetic base body; and
an insulation layer covering an area of the first surface that excludes areas on which the external electrodes are disposed.

2. The coil component according to claim 1, wherein the second electrode portion is located within a contour of the corresponding first electrode portion when viewed in a direction perpendicular to the first surface.

3. The coil component according to claim 1, wherein peripheries of the first electrode portion are covered with the insulation layer.

4. The coil component according to claim 1, wherein the first electrode portions have a thickness that is greater than a thickness of the second electrode portions.

5. The coil component according to claim 1, wherein, in the direction perpendicular to the first surface, the external electrodes protrude beyond the insulation layer.

6. The coil component according to claim 1, wherein at least a part of a surface of the insulation layer has a sloping surface that is inclined to be closer to the first surface as a distance from the external electrodes increases.

7. The coil component according to claim 1, wherein, on the first surface, the insulation layer is wider than the second electrode portions.

8. The coil component according to claim 1, wherein the magnetic base body has multiple surfaces including the first surface, and wherein the external electrodes are disposed only on the first surface among the multiple surfaces.

9. The coil component according to claim 1, wherein the insulation layer has a surface roughness that is less than that of the magnetic base body.

10. The coil component according to claim 1, wherein the insulation layer is made of at least one insulating material among resins, glass materials, and metal oxides.

11. The coil component according to claim 1, in the direction perpendicular to the first surface, the insulation layer protrudes beyond the external electrodes.

12. The coil component according to claim 1, wherein the first electrode portions are mainly composed of a metallic element that is the same as that for the conductor.

13. The coil component according to claim 1, wherein the second electrode portions contain Cu at least on surfaces thereof.

14. The coil component according to claim 1, comprising three or more external electrodes.

15. The coil component according to claim 1, comprising multiple conductors, each of which is an inductor element.
